(19) United States
(12) Patent Application Publication
(10) Pub. No.: US 2026/0210522 A1
(43) Pub. Date: Jul. 23, 2026

(54) LIGHTING MODULE WITH TOP CONTACT AND SURFACE MOUNT LEDS

(71) Applicant: Lumileds LLC, San Jose, CA (US)

(72) Inventors: Joseph Hendrik Anna Maria Jacobs, Eygelshoven (NL); Marc Droegeler, Aachen (DE)

(73) Assignee: Lumileds LLC, San Jose, CA (US)

(21) Appl. No.: 19/137,881

(22) PCT Filed: Dec. 12, 2023
(86) PCT No.: PCT/US2023/083505

§ 371 Date: Jun. 11, 2025

Related U.S. Application Data
(60) Provisional application No. 63/432,494, filed on Dec. 14, 2022.

(51) Int. Cl. F21S 45/47; F21S 41/141; F21S 41/20; F21S 41/30

(52) U.S. Cl. CPC F21S 45/47; F21S 41/141; F21S 41/285; F21S 41/30

(57) ABSTRACT

Lighting modules combining top-contact LEDs and surface mount LEDs are described. The top-contact LEDs are mounted directly to a heat sink and are electrically connected by ultrasonically bonded conductors to a PCB containing the surface mount LEDs. The modules may also comprise a lens assembly configured to combine light emitted by the top contact LEDs and the surface mount LEDs into a composite beam.

### CROSS-REFERENCE TO RELATED APPLICATIONS

This application claims the benefit of U.S. Provisional Application No. 63/432,494, filed Dec. 14, 2022, the contents of which are incorporated herein by reference.

### BACKGROUND

Advances in light emitting diode (LED) technology have made LEDs a viable alternative to traditional incandescent lamps in many areas. One area where LEDS are making inroads is automotive lighting and in particular signal and headlamp lighting.

### SUMMARY

Lighting modules combining top-contact LEDs and surface mount LEDs are described. The top-contact LEDs are mounted directly to a heat sink and are electrically connected by ultrasonically bonded conductors to a PCB containing the surface mount LEDs. The surface mount LEDs may be soldered to the PCB. The modules may also comprise a lens assembly configured to combine light emitted by the top contact LEDs and the surface mount LEDs into a composite beam.

### BRIEF DESCRIPTION OF THE DRAWINGS

A more detailed understanding can be had from the following description, given by way of example in conjunction with the accompanying drawings wherein:

FIG. 1 shows an example LED automotive projection headlamp assembly;

FIG. 2 is a block diagram of an example multi-led automotive headlamp;

FIG. 3 is perspective drawing of an example surface mount LED;

FIG. 4 is a perspective drawing of an example top contact LED;

FIG. 5 is a perspective view of an example top-contact LED with electrical connections to a PCB;

FIG. 6 is a perspective view of another example top-contact LED with electrical connections to a PCB;

FIG. 7 is a side view of an example top-contact LED with electrical connections to a PCB;

FIG. 8 is a perspective view of an example top-contact LED with electrical connections to a PCB that are coated;

FIG. 9 is a perspective view of an example lighting assembly with top-contact and surface mount LEDs;

FIG. 10 is a schematic block diagram of an example vehicle headlamp system; and

FIG. 11 is a block diagram of an example vehicle headlamp system.

### DETAILED DESCRIPTION

Examples of different light illumination systems and/or light emitting diode (“LED”) implementations will be described more fully hereinafter with reference to the accompanying drawings. These examples are not mutually exclusive, and features found in one example may be combined with features found in one or more other examples to achieve additional implementations. Accordingly, it will be understood that the examples shown in the accompanying drawings are provided for illustrative purposes only and they are not intended to limit the disclosure in any way. Like numbers refer to like elements throughout.

It will be understood that, although the terms first, second, third, etc. may be used herein to describe various elements, these elements should not be limited by these terms. These terms may be used to distinguish one element from another. For example, a first element may be termed a second element and a second element may be termed a first element without departing from the scope of the present invention. As used herein, the term “and/or” may include any and all combinations of one or more of the associated listed items.

It will be understood that when an element such as a layer, region, or substrate is referred to as being “on” or extending “onto” another element, it may be directly on or extend directly onto the other element or intervening elements may also be present. In contrast, when an element is referred to as being “directly on” or extending “directly onto” another element, there may be no intervening elements present. It will also be understood that when an element is referred to as being “connected” or “coupled” to another element, it may be directly connected or coupled to the other element and/or connected or coupled to the other element via one or more intervening elements. In contrast, when an element is referred to as being “directly connected” or “directly coupled” to another element, there are no intervening elements present between the element and the other element. It will be understood that these terms are intended to encompass different orientations of the element in addition to any orientation depicted in the figures.

Relative terms such as “below,” “above,” “upper,”, “lower,” “horizontal” or “vertical” may be used herein to describe a relationship of one element, layer, or region to another element, layer, or region as illustrated in the figures. It will be understood that these terms are intended to encompass different orientations of the device in addition to the orientation depicted in the figures.

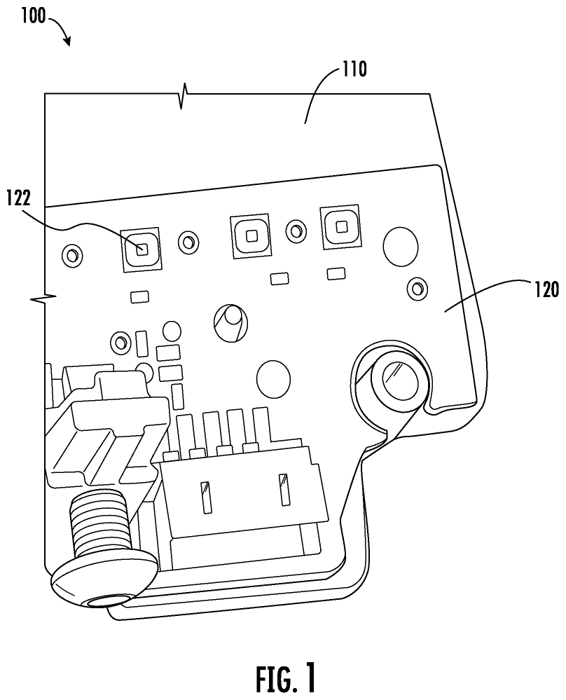

Automotive projection headlight applications often use multiple distributed LEDs to achieve one function. An example of such an automotive projection headlamp is shown in FIG. 1 and described in more detail below.

FIG. 1 shows a portion of an LED automotive projection headlamp assembly 100. In the example illustrated in FIG. 1, the assembly includes a PCB 120 with multiple LEDs 122 mounted to the PCB 120. The LEDs 122 are surface mount devices (SMDs), which may be directly mounted to the PCB 120 via their bottom surfaces, such as by soldering the LEDs 122 to solder pads on the PCB 120. The PCB 120 is shown mounted to a lamp assembly chassis 110, which may be a heat sink. The LEDs 122 may feed collimator optics, a total internal reflection (TIR) optic or a reflector, which may guide the beam to a lens.

Beam pattern for automotive headlamps is very specific and critical. Multiple LEDs 122 may be used to obtain an optimized beam on the road. Multiple LEDs may provide more flexible design options for optimizing beam shape and intensity while producing a more homogenous beam.

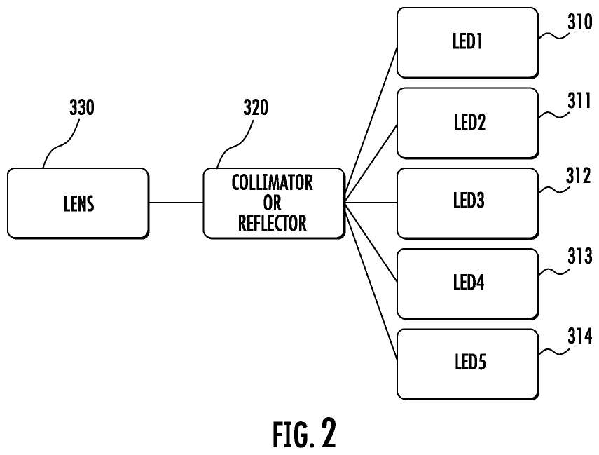

FIG. 2 is a block diagram of a multi-LED automotive headlamp. The headlamp may include a plurality of individual LEDs 310, 311, 312, 313, 314. Light output from the LEDs may be directed to one or more collimators, TIRs and/or reflectors 320. In embodiments, each LED is associated with a single reflector or a single TIR lens. Multiple reflectors and/or TIR lenses may be aligned to produce a composite light beam. Light output from the collimators and/or reflectors 320 may be alternatively directed to one or more lenses 330. In embodiments, top contact LEDs may be used for low beam and SMDs for light effects. The SMDs may feed one or more light pipes for functions such as daytime running lights (DRLs). SMD LEDs with having different color temperature that the top contact LEDs may be used in embodiments to adjust the overall light color of a headlamp.

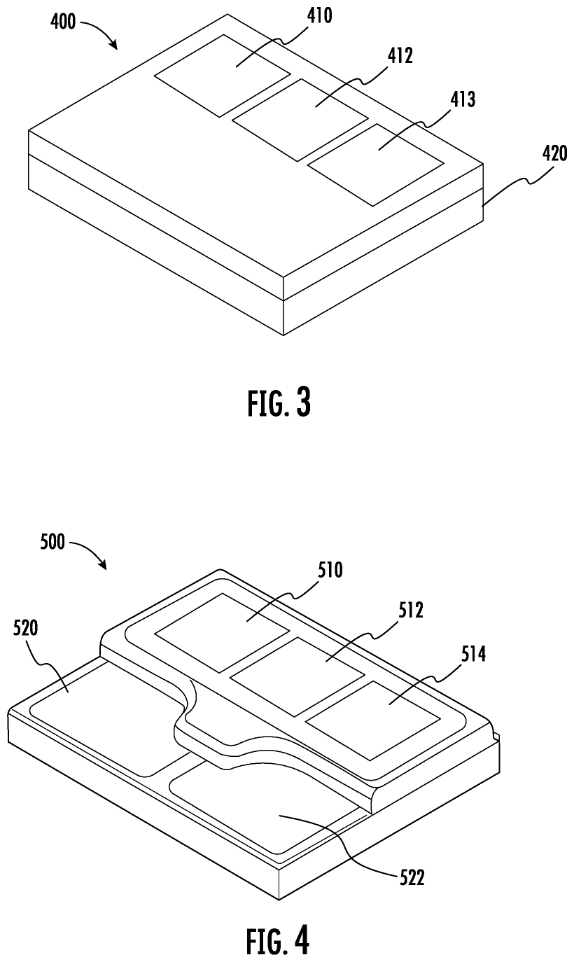

FIG. 3 is a perspective drawing of an exemplary surface mount LED 400. The LED has three light outputs 410, 412, 413 on a substrate 420. Power may be supplied to the LED 400 by surface mount contacts (not shown) on the bottom of the substrate 420. The surface mount contacts are typically soldered to a printed circuit board (PCB) or an insulated metal substrate (IMS). Additionally, thermal contacts (not shown) may also be provided on the bottom surface of the substrate 420 for dissipating heat from the LED 400 to a heat sink through the bottom surface of the substrate 420. Both types of contacts, the thermal contacts and the electrical contacts, may be soldered to the PCB or IMS.

FIG. 4 is a perspective drawing of an exemplary top-contact LED 500. The LED has three light outputs 510, 512, 514. Power may be supplied to the LED 500 by top-side contacts 520, 522. The top-side contacts 520, 522 are typically powered via conductors that may be ultrasonically bonded to the top-side contacts. For example, ribbon or wire bonds (not shown in FIG. 4) may be electrically coupled between the top-side contacts 520 and 522 and the PCB on which they are mounted. Power may thereby be provided to the LED emitters 510, 512 and 514 via the PCB.

SMD LEDs have a number of advantages that make them desirable for use in LED headlamps or signal lamps, for example. SMD LEDs can be easily soldered directly to the PCB as no fragile top wires or ribbons are needed to make the electrical connection. Further, since there are no top contacts taking up space on the PCB, SMD LEDs can conceivably be located closer together if all other optical challenges can be overcome and, since they take up less space on the PCB, more valuable PCB space can be used for other purposes, such as for mounting passive electronic or other components.

However, SMD LEDs come with certain drawbacks. As compared to top-contact LEDs, such as shown in FIG. 4, for example, SMD LEDs have a smaller thermal contact on the bottom surface because both the electricity and heat dissipation need be routed through the bottom surface of the LED, leaving less room for both types of pads. This means that top-contact LEDs typically have better thermal performance, which may result in better optical performance as well. Additionally, top-contact LEDs can be glued directly to the heatsink, which can make them more efficient at dissipating heat than SMDs. The glue can be a silver filled silicone glue in some embodiments, which absorbs coefficient of thermal expansion (CTE) mismatches extremely well, providing very good reliability as compared to solder. Such LEDs, thus, may have a very high lifespan. The gluing also makes direct LED alignment easy and highly accurate. The glue can be cured in an oven at a maximum temperature of 200° C., which puts less stress on the LED compared to soldering. Precision location of the LED is important when using highly focused LEDs because the center of the light source must be properly located with respect to other optical elements such as collimators, lenses and reflectors. Even a small offset from the desired location of the device can result in decreased light output or improper location of an output beam.

In contrast to SMDs, top-contact LEDs are only limited by the maximum junction temperature, which may be 150° for long term heating and 180° for short term heating. SMD LEDs are limited by both the junction temperature as well as the solder temperature. Accordingly, the total thermal resistance is higher for SMD LEDs, which may result in lower thermal performance and hence lower optical performance for such LEDs.

While wire bond connections which top contact LEDs require, are typically more reliable than solder connections, they are also more expensive to manufacture and mount to a PCB. Additionally, due to the reduced surface emission area available for top-contact LEDs, it may be desirable to include a certain ratio or amount of SMD LEDs in an arrangement with top contact LEDs to attain a particular output brightness necessary for automotive lighting applications. Accordingly, it may be desirable to include a combination of both SMD and top-contact LEDs in an arrangement for use, for example, in automotive lighting. Additionally, while ultrasonic top-contact bonds are extremely reliable, especially in comparison to SMD bonds, it may be desirable to find less expensive mechanisms to create a reliable top-contact for such top-contact LEDs as customers are becoming more demanding on suppliers in terms of both quality and cost, putting pressure on suppliers to find ways to make high quality LED applications more affordable. Thus the cost of electrical connections for top contact LEDs may eventually come down, making them an overall more desirable choice.

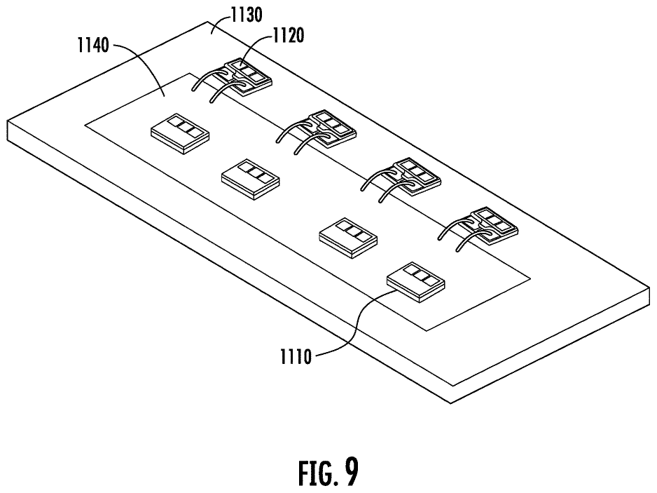

FIG. 9 is a perspective view of an example lighting assembly with top-contact and surface mount LEDs. The example lighting assembly illustrated in FIG. 9 combines both surface mount LEDs 1110 and top-contact LEDs 1120. As can be seen in FIG. 9, the top-contact LEDs 1120 may be directly glued to the heat sink 1130, for example via a thermally conductive adhesive. The adhesive may also be electrically conductive or may be electrically insulating. The SMD LEDs 1110 may be mounted to a PCB 1140 or another suitable substrate type. In such embodiments, the top-contact LEDs 1120 may be electrically coupled via connectors (not shown in FIG. 9), such as ribbon or wire bonds, to the PCB 1140, which may be a conduit for supplying power from an external power source to the top-contact LEDs that may be glued directly to the heat sink 1130. The PCB 1140 may, thus, provide electrical connections between the surface mount LEDS 1110, the top-contact LEDs 1120, any other on-board components and external power and signaling. In embodiments, the PCB 1140 is an insulated metal substrate circuit board, which, in further embodiments may transfer heat, generated by the surface mount LEDs 1110 to the heatsink 1130.

The top-contact LEDs 1120 are typically the most thermally efficient of the two types of LEDs and, thus, can be operated under higher power than their SMD counterparts. Accordingly, in embodiments the top-contact LEDs 1120 may provide the dominant source of light output of the assembly while the surface mount LEDs 1110 may be used to augment the strong light output of the top-contact LEDs. For example, the SMD LEDs can help with beam shaping or beam improvement; or can be used as glow lights, or in low beam lighting, or high beam lighting, or fog lighting.

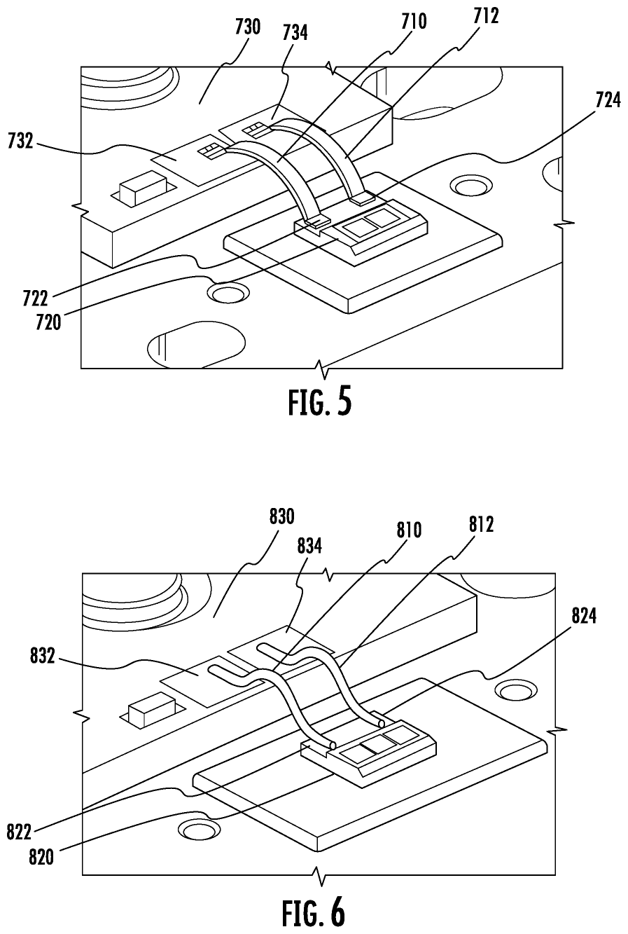

FIG. 5 shows a pair of flat or ribbon electrical conductors 710, 712 ultrasonically bonded to contacts 722, 724 on the top-contact LED 720 and to contacts 732, 734 on the PCB 730. FIG. 6 shows a pair of circular cross-section or wire electrical conductors 810, 812 ultrasonically bonded to contacts 822, 824 on the top-contact LED 820 and to contacts 832, 834 on the PCB 830. Ribbon and wire bonding are the two conventional ways of making top contacts for top-contact LEDs. However, as noted above, to make the top-contacts reliable, they require precision mounting and are, correspondingly, expensive to manufacture and mount. However, there are some techniques that can be used to improve the connection while minimizing the expense of doing so. Some of these techniques can be performed by the LED manufacturer and, thus, the LEDs made using these techniques can be shipped to the customer in a form that is easier and less expensive for them to mount on their own control or other boards, for example.

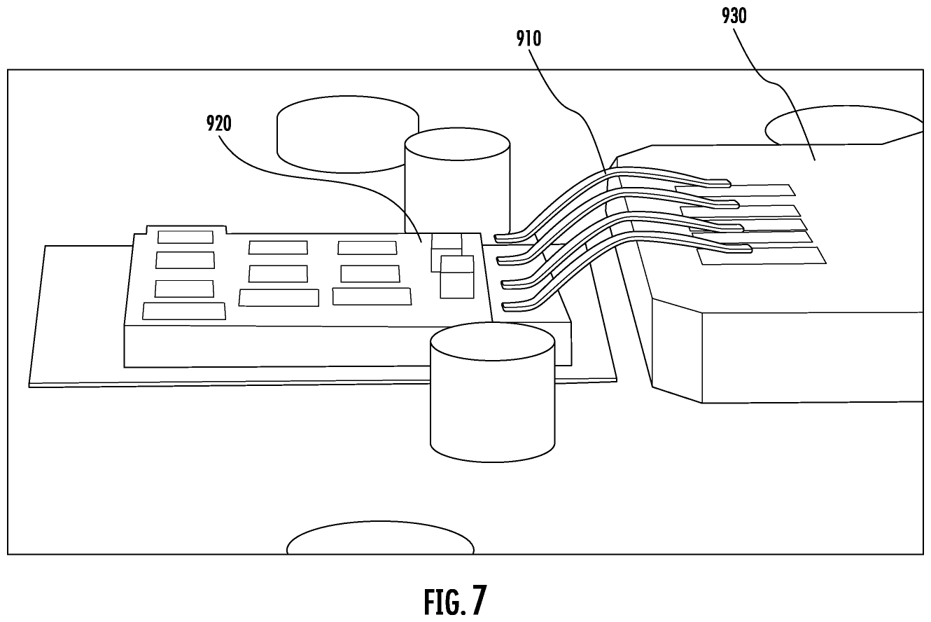

FIG. 7 shows a side view of wire-shaped electrical conductors 910 connecting pads on a top contact LED 920 and a PCB 930. In this embodiment, the height difference between the PCB and the LED prevent the conductors from being able to short against an electrically conductive heatsink in the event that they are disturbed (e.g., pressed down so as to touch the heatsink) in the manufacturing process or otherwise during handling of the assembly. No additional materials or new production tools may be needed to form the bonds in this manner as the height difference and bend shape of the wires and/or ribbons themselves prevent the shorting from happening. However, a product redesign may be needed to rearrange the PCB to enable this layout. Additionally, optical shadowing is possible due to the LEDs being lower in height than the PCB.

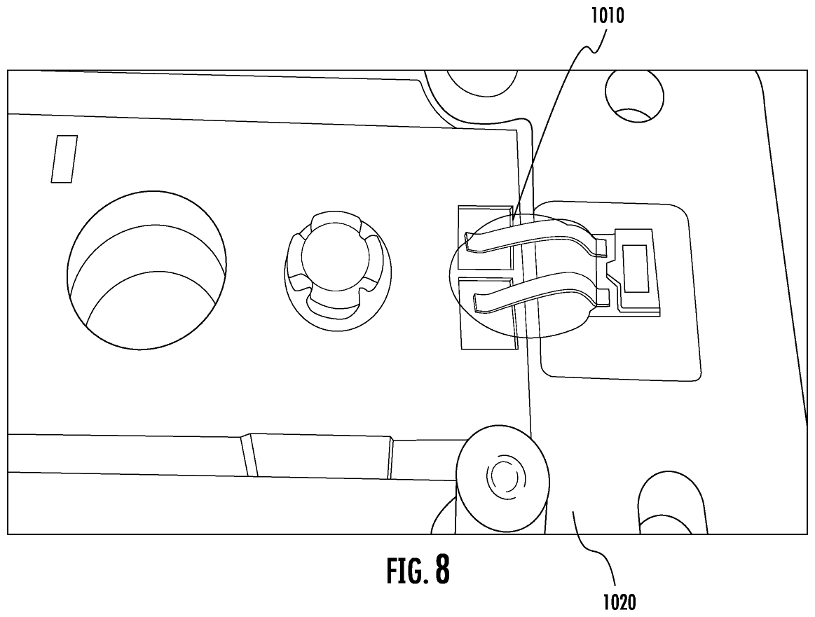

FIG. 8 shows an embodiment wherein the electrical conductors are coated with a coating 1010 to prevent accidental shorting against a heatsink 1020 during manufacturing or handling of the assembly. In embodiments, the coating 1010 may have a comparable coefficient of thermal expansion to that of the heatsink 1020 to prevent unequal expansion of the heatsink and the coating, which could cause the coating to fail and break the conductors or pull them off the weld at the LED or the PCB.

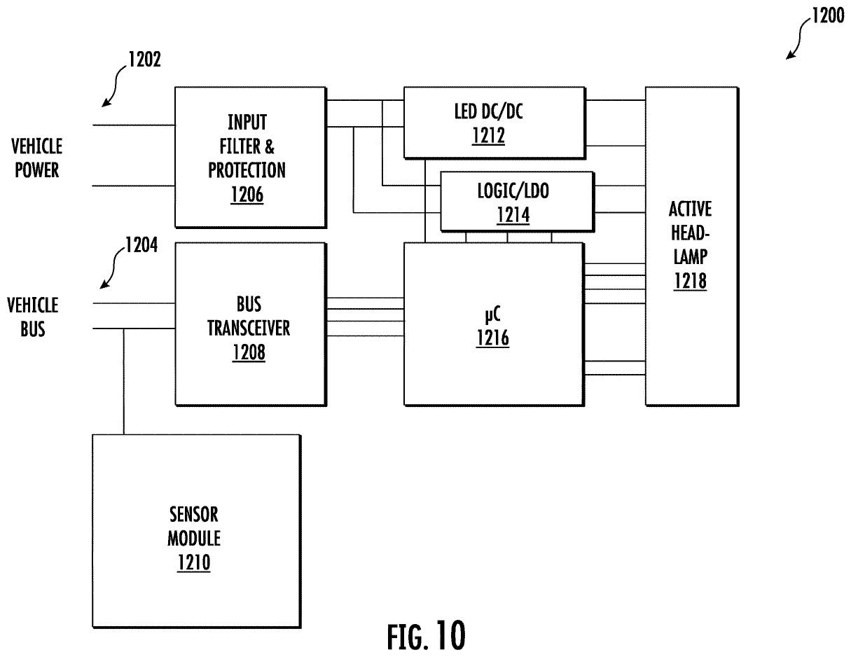

FIG. 10 is a diagram of an example vehicle headlamp system 1200 that may incorporate one or more of the embodiments and examples described herein. The example vehicle headlamp system 1200 illustrated in FIG. 10 includes power lines 1202, a data bus 1204, an input filter and protection module 1206, a bus transceiver 1208, a sensor module 1210, an LED direct current to direct current (DC/DC) module 1212, a logic low-dropout (LDO) module 1214, a micro-controller 1216 and an active head lamp 1218.

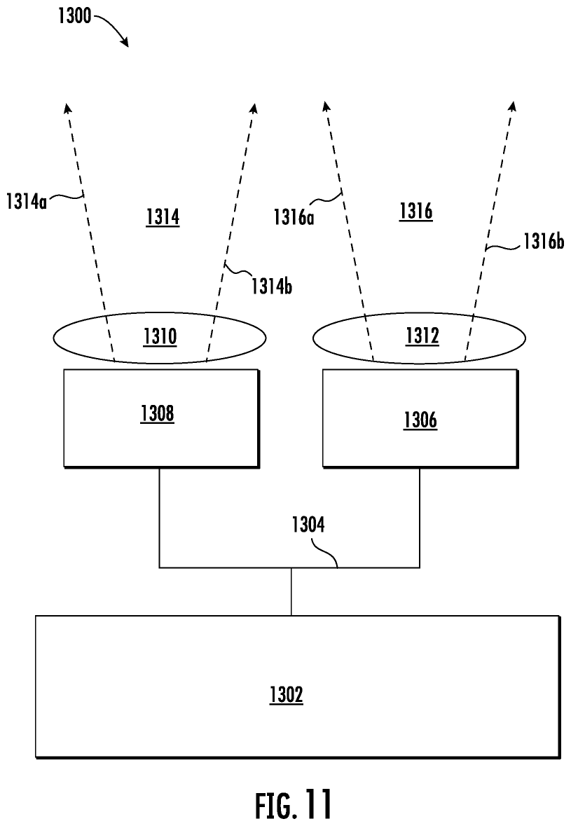

FIG. 11 is a diagram of another example vehicle headlamp system 1300. The example vehicle headlamp system 1300 illustrated in FIG. 11 includes an application platform 1302, two LED lighting systems 1306 and 1308, connected to the application platform by conductors 1304, and secondary optics 1310 and 1312.

The LED lighting system 1308 may emit light beams 1314 (shown between arrows 1314a and 1314b in FIG. 11). The LED lighting system 1306 may emit light beams 1316 (shown between arrows 1316a and 1316b in FIG. 11). In the embodiment shown in FIG. 1, a secondary optic 1310 is adjacent the LED lighting system 1308, and the light emitted from the LED lighting system 1308 passes through the secondary optic 1310. Similarly, a secondary optic 1312 is adjacent the LED lighting system 1306, and the light emitted from the LED lighting system 1306 passes through the secondary optic 1312. In alternative embodiments, no secondary optics 1310/1312 are provided in the vehicle headlamp system.

Where included, the secondary optics 1310/1312 may be or include one or more light guides. The one or more light guides may be edge lit or may have an interior opening that defines an interior edge of the light guide. LED lighting systems 1308 and 1306 may be inserted in the interior openings of the one or more light guides such that they inject light into the interior edge (interior opening light guide) or exterior edge (edge lit light guide) of the one or more light guides. In embodiments, the one or more light guides may shape the light emitted by the LED lighting systems 1308 and 1306 in a desired manner, such as, for example, with a gradient, a chamfered distribution, a narrow distribution, a wide distribution, or an angular distribution.

The application platform 1302 may provide power and/or data to the LED lighting systems 1306 and/or 1308 via conductors 1304, which may include one or more or a portion of the power lines 1202 and the data bus 1204 of FIG. 10. One or more sensors (which may be the sensors in the vehicle headlamp system 1300 or other additional sensors) may be internal or external to the housing of the application platform 1302. Alternatively, or in addition, as shown in the example vehicle headlamp system 1300 of FIG. 11, each LED lighting system 1308 and 1306 may include its own sensor module, connectivity and control module, power module, and/or LED array.

In embodiments, the vehicle headlamp system 1300 may represent an automobile with steerable light beams where LEDs may be selectively activated to provide steerable light. For example, an array of LEDs or emitters may be used to define or project a shape or pattern or illuminate only selected sections of a roadway. In an example embodiment, infrared cameras or detector pixels within LED lighting systems 1306 and 1308 may be sensors (e.g., similar to sensors in the sensor module 1210 of FIG. 10) that identify portions of a scene (e.g., roadway or pedestrian crossing) that require illumination.

In an embodiment, there is a lighting assembly comprising: a heat sink; a printed circuit board (PCB); a first light emitting diode (LED) mounted on the heat sink; and a second LED mounted on the PCB; the first and second LEDs being electrically connected to circuitry on the PCB. In further embodiments, the first LED is a top-contact LED and the second LED is a surface mount LED. In further embodiments, the first LED is electrically connected to the circuitry on the PCB by an electrical conductor that is ultrasonically bonded at a first conductor end to a first LED contact surface and is ultrasonically bonded at a second conductor end to a first PCB conductor pad. In further embodiments, the electrical conductor is either a ribbon-shaped conductor having a substantially rectangular cross-section or a wire-shaped conductor having a substantially circular cross-section. In further embodiments, the first LED is affixed to the heat sink by thermally-conductive adhesive. In further embodiments, the second LED is electrically connected to the circuitry on the PCB by solder. In further embodiments, the first LED has a higher light output than the second LED. In further embodiments, the PCB is mounted on the heat sink adjacent to the first LED. In further embodiments, the PCB comprises an insulated metal substrate.

In an embodiment, there is a method of manufacturing a lighting assembly comprising light emitting diodes (LEDs) comprising: adhering a top-contact LED to a heat sink; soldering first electrical contacts of a surface mount LED to second electrical contacts on a printed circuit board (PCB); ultrasonically bonding an electrical conductor to a third electrical contact on the top-contact LED; and ultrasonically bonding the electrical conductor to a fourth electrical contact on the PCB. Further embodiments include adhering the top contact LED to the heat sink with a thermally conductive adhesive. Further embodiments include the electrical conductor being an electrically conductive wire or an electrically conductive ribbon. Further embodiments include mounting the PCB onto the heatsink.

In an embodiment, there is an automotive headlamp comprising: an electronics module comprising: a heat sink; a printed circuit board (PCB); a top-contact light emitting diode (LED) mounted on the heat sink; and a surface mount LED mounted on the PCB; the first and second LEDs being electrically connected to circuitry on the PCB; and a lens assembly comprising; a first optical element for directing light emitted by the top-contact LED and a second optical element for directing light emitted by the surface mount LED. In further embodiments, the top-contact LED is electrically connected to the circuitry on the PCB by an electrical conductor that is ultrasonically bonded at a first conductor end to a first LED contact surface and is ultrasonically bonded at a second conductor end to a first PCB conductor pad. In further embodiments, the top-contact LED is affixed to the heat sink by thermally-conductive adhesive. In further embodiments, the top-contact LED has a higher light output than the surface mount LED. In further embodiments, the first optical element is a reflector or a total internal reflection lens. In further embodiments, the second optical element is a reflector, a total internal reflection lens or a light pipe. In further embodiments, the first optical element and the second optical element are configured to form a composite light beam comprising the light emitted by the top-contact LED and the light emitted by the surface mount LED.

As would be apparent to one skilled in the relevant art, based on the description herein, embodiments of the present invention can be designed in software using a hardware description language (HDL) such as, for example, Verilog or VHDL. The HDL-design can model the behavior of an electronic system, where the design can be synthesized and ultimately fabricated into a hardware device. In addition, the HDL-design can be stored in a computer product and loaded into a computer system prior to hardware manufacture.

Having described the embodiments in detail, those skilled in the art will appreciate that, given the present description, modifications may be made to the embodiments described herein without departing from the spirit of the inventive concept. Therefore, it is not intended that the scope of the invention be limited to the specific embodiments illustrated and described.

1. A lighting assembly comprising:
a heat sink;
a printed circuit board (PCB);
first light emitting diode (LED) mounted on the heat sink; and
a second LED mounted on the PCB;
the first and second LEDs being electrically connected to circuitry on the PCB;
wherein no part of the first LED is mounted on the PCB and no part of the second LED is mounted on the heat sink.

2. The lighting assembly of claim 1, wherein the first LED is a top-contact LED and the second LED is a surface mount LED.

3. The lighting assembly of claim 2, wherein the first LED is electrically connected to the circuitry on the PCB by an electrical conductor that is ultrasonically bonded at a first conductor end to a first LED contact surface and is ultrasonically bonded at a second conductor end to a first PCB conductor pad.

4. The lighting assembly of claim 3, wherein the electrical conductor is either a ribbon-shaped conductor having a substantially rectangular cross-section or a wire-shaped conductor having a substantially circular cross-section.

5. The lighting assembly of claim 2, wherein the first LED is affixed to the heat sink by thermally-conductive adhesive.

6. The lighting assembly of claim 2, wherein the second LED is electrically connected to the circuitry on the PCB by solder.

7. The lighting assembly of claim 1, wherein the first LED has a higher light output than the second LED.

8. The lighting assembly of claim 1, wherein the PCB is mounted on the heat sink adjacent to the first LED.

9. The lighting assembly of claim 1, wherein the PCB comprises an insulated metal substrate.

10. A method of manufacturing a lighting assembly comprising light emitting diodes (LEDs) comprising:
adhering a top-contact LED to a heat sink;
soldering first electrical contacts of a surface mount LED to second electrical contacts on a printed circuit board (PCB);
ultrasonically bonding an electrical conductor to a third electrical contact on the top-contact LED; and
ultrasonically bonding the electrical conductor to a fourth electrical contact on the PCB;
wherein no part of the top-contact LED is mounted on the PCB and no part of the surface mount LED is mounted on the heat sink.

11. The method of manufacturing of claim 10, further comprising adhering the top contact LED to the heat sink with a thermally conductive adhesive.

12. The method of manufacturing of claim 10, further comprising the electrical conductor being an electrically conductive wire or an electrically conductive ribbon.

13. The method of manufacturing of claim 10, further comprising mounting the PCB onto the heatsink.

14. An automotive headlamp comprising:
an electronics module comprising:
a heat sink;
a printed circuit board (PCB);
a top-contact light emitting diode (LED) mounted on the heat sink;
and
a surface mount LED mounted on the PCB;
the top-contact first and surface mount second LEDs being electrically connected to circuitry on the PCB;
wherein no part of the top-contact LED is mounted on the PCB and no part of the surface mount LED is mounted on the heat sink; and
a lens assembly comprising;
a first optical element for directing light emitted by the top-contact LED and
a second optical element for directing light emitted by the surface mount LED.

15. The automotive headlamp of claim 14, wherein the top-contact LED is electrically connected to the circuitry on the PCB by an electrical conductor that is ultrasonically bonded at a first conductor end to a first LED contact surface and is ultrasonically bonded at a second conductor end to a first PCB conductor pad.

16. The automotive headlamp of claim 15, wherein the top-contact LED is affixed to the heat sink by thermally-conductive adhesive.

17. The automotive headlamp of claim 15, wherein the top-contact LED has a higher light output than the surface mount LED.

18. The automotive headlamp of claim 15, wherein the first optical element is a reflector or a total internal reflection lens.

19. The automotive headlamp of claim 15, wherein the second optical element is a reflector, a total internal reflection lens or a light pipe.

20. The automotive headlamp of claim 15, wherein the first optical element and the second optical element are configured to form a composite light beam comprising the light emitted by the top-contact LED and the light emitted by the surface mount LED.
